(19) United States
(12) Patent Application Publication
(10) Pub. No.: US 2013/0177860 A1
(43) Pub. Date: Jul. 11, 2013

(54) Quenching Chamber with an Integral Access Door

(71) Applicant: IPSEN, INC., Cherry Valley, IL (US)

(72) Inventors: Jake Hamid, Oakwood Hills, IL (US); Craig A. Moller, Roscoe, IL (US); Hendrik Grobler, Clyde Park, MT (US)

(73) Assignee: IPSEN, INC., Cherry Valley, IL (US)

(21) Appl. No.: 13/723,368

(22) Filed: Dec. 21, 2012

Related U.S. Application Data
(60) Provisional application No. 61/579,058, filed on Dec. 22, 2011.

(51) Int. Cl. F27D 9/00

(52) U.S. Cl. CPC F27D 9/00
USPC 432/85; 432/77

(57) ABSTRACT

A quenching apparatus is disclosed which has a generally cylindrical base and upper housing. A removable cover is affixed to the top of the upper housing. The quenching apparatus includes means for supporting the removable cover above the upper housing such that a passageway is defined between the upper housing and the removable cover. A generally cylindrical door is dimensioned and positioned within the quenching apparatus to be coaxial within the upper housing and the base. An actuator is coupled to the cylindrical door for moving the door between an open position and a closed position. In this manner, the door is adapted for closing the opening between the base and the upper housing and thereby provides a closed quenching chamber. Redundant retractable seals are provided in the base and the upper housing to seal the door to the upper housing and the base when the door is closed.

### CROSS REFERENCE TO RELATED APPLICATION

This application claims the benefit of U.S. Provisional Application No. 61/579,058, filed Dec. 22, 2011, the entirety of which is incorporated herein by reference.

### BACKGROUND OF THE INVENTION

1. Field of the Invention

This invention relates generally to heat treating systems for metals and other heat treatable materials and in particular to a multipurpose quenching chamber for cooling a load of heat treated parts.

2. Background of the Invention

There are known heat treating systems that include multiple treating chambers and a transport module for transporting a work load between the multiple treating chambers. In some of the known systems, the transport module is centrally located relative to the multiple treating chambers. In other known systems the treating chambers are arrayed linearly and the transport module moves on linear tracks. In many of the known systems the chamber door is located outside of the chamber itself. Of the systems with centrally located transport modules, the transport modules either have multiple doors for accessing the other stations or have a specialized docking arrangement to permit coupling to the other treating chambers. In the known systems, redundant closing means are required in order to ensure that no oxygen enters the designated treating chamber. The known arrangements for closing the treating chamber leave something to be desired because of their complexity. Effective sealing is difficult to achieve because the closure devices are appended to the exterior of the chamber.

In most of the multi-station heat treating systems, the quenching chamber is separate and stationary. The centralized transporter mechanism is functionally limited to loading and unloading workloads to and from the several treating chambers. The transport module used in the linearly arrayed system is usually equipped to maintain the workload under vacuum and at temperature. A separate movable quenching chamber is provided in the linear array system that can function as an alternate transport module. However, the movable quenching chamber is limited to the use of gas quenching. When other types of quenching media are used, the workload must be transported to the quenching chamber that is set up for the desired quenching medium. Moreover, the linear arrangement has the disadvantage of requiring complex connections for power, control, water, and gas.

In view of the shortcomings of the known multi-station heat treating systems it would be desirable to have a stationary quenching chamber that can be used with multiple quenching media and which can be readily accessed from multiple directions for use with an array of treating chambers and a loading/unloading station.

### SUMMARY OF THE INVENTION

The disadvantages of the known multi-station heat treating systems are resolved to a large degree by a quenching apparatus in accordance with the present invention. According to a first aspect of the present invention there is provided a quenching apparatus having a generally cylindrical base and upper housing. A removable cover having a generally cylindrical portion that is open at a lower end thereof and a domed portion affixed to an upper end of the cylindrical portion is affixed to the top of the upper housing. The quenching apparatus also includes means for supporting the removable cover above the upper housing in spaced, coaxial relation such that a passageway is defined between the upper housing and the removable cover. A generally cylindrical door is dimensioned and positioned within the quenching apparatus to be coaxial with the upper housing and the base. An actuator is coupled to the cylindrical door for moving the door between an open position inside the removable cover and a closed position wherein the door extends between the upper housing and the base. In this manner, the door is adapted for closing the opening between the base and the upper housing and thereby provides a closed quenching chamber. Redundant retractable seals are provided in the base and the upper housing to seal the door to the upper housing and the base so that when in use, the quench chamber can be maintained at a superatmospheric gas pressure or under vacuum, depending on the quenching cycle being used.

In a first embodiment of the quenching apparatus according to this invention, the opening between the upper housing and the base extends through an angle of 360° so that a workload can be readily moved into or out of the quenching apparatus at any one of a plurality of positions. In an alternative embodiment the quenching apparatus includes a generally cylindrical wall situated coaxially between and commensurate with the base and the upper housing so as to enclose the opening between the base and the upper housing. The cylindrical wall has two or more ports formed therein at spaced angular locations around the circumference of the wall. The ports are dimensioned to permit a workload to be moved therethrough.

In accordance with a further embodiment of the present invention there is provided a quenching apparatus having a generally cylindrical housing. The housing has two or more ports positioned in spaced angular relation around the circumference of the housing and at least one area without a port. The quenching apparatus includes a generally spherical quenching chamber rotatably mounted within the housing. The quenching chamber has a single port formed in its wall. An actuator is operatively coupled to the quenching chamber to rotate the chamber within the housing to a position where said single port is aligned with a port in the housing and to a position where the single port is aligned with the position without a port in the housing. One or more retractable seals are positioned between the wall of the spherical quenching chamber and the housing. The seals are constructed and arranged to provide a pressure-tight seal against superatmospheric pressure or vacuum inside the quenching chamber and to be withdrawn when the quenching chamber is being rotated.

The quenching apparatus in accordance with the present invention is adapted to be used with a variety of quenching media including, but not limited to, gas quenching, liquid quenching, and cryogenic fluid quenching.

### BRIEF DESCRIPTION OF THE DRAWINGS

The foregoing summary as well as the following detailed description will be better understood when read with reference to the several views of the drawing, wherein:

FIG. 1 is an elevation view of a first embodiment of a quenching apparatus in accordance with the present invention wherein the chamber door is in an open position;

FIG. 2 is an elevation view of the quenching apparatus of FIG. 1 with the chamber door in the closed position;

FIG. 3 is a schematic, cross-sectional plan view of the quenching apparatus of FIG. 1 as viewed along line 3-3 in FIG. 1;

FIG. 4 is a schematic, cross-sectional elevation view of the quenching apparatus of FIG. 1 as viewed along line 4-4 of FIG. 1;

FIG. 5 is an elevation view of another embodiment of the quenching apparatus according to the present invention with a gas recirculation chamber connected thereto;

FIG. 6 is a schematic, cross-sectional elevation view of the quenching apparatus shown in FIG. 5;

FIG. 7 is an elevation view in partial section of a second embodiment of a quenching apparatus in accordance with the present invention;

FIG. 8 is a schematic, cross-sectional plan view of a further embodiment of the quenching apparatus in accordance with the present invention;

FIG. 9 is a top plan view of a second embodiment of the quenching apparatus in accordance with this invention;

FIG. 10 is a side elevation view in partial section of the quenching apparatus of FIG. 9 as viewed along line 10-10 therein; and

FIG. 11 is a perspective view in partial section of a second embodiment of the gas recirculation arrangement used in the quenching apparatus according to this invention.

### DETAILED DESCRIPTION

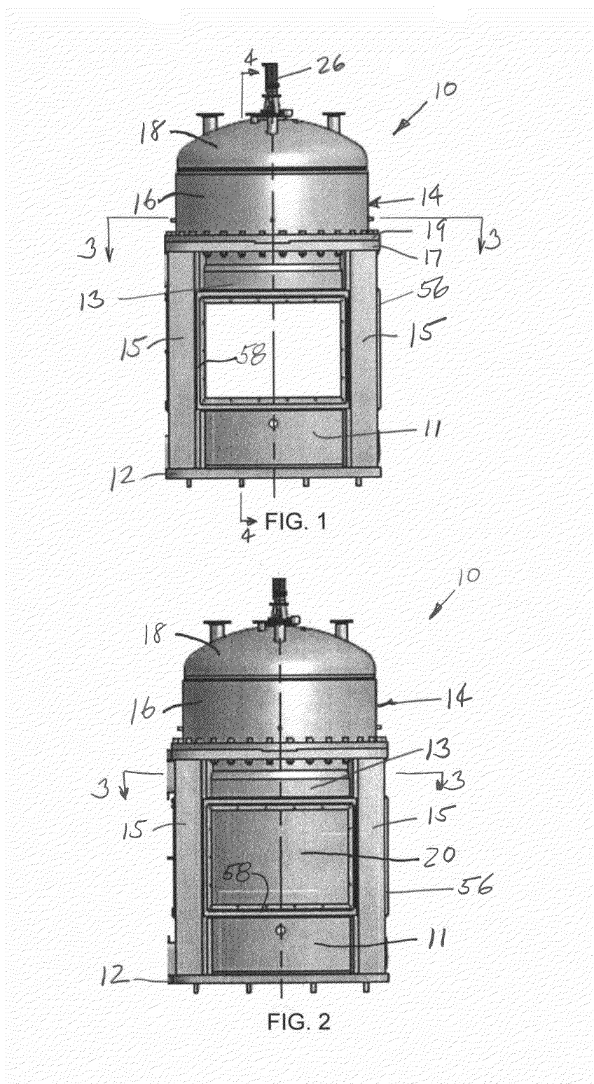

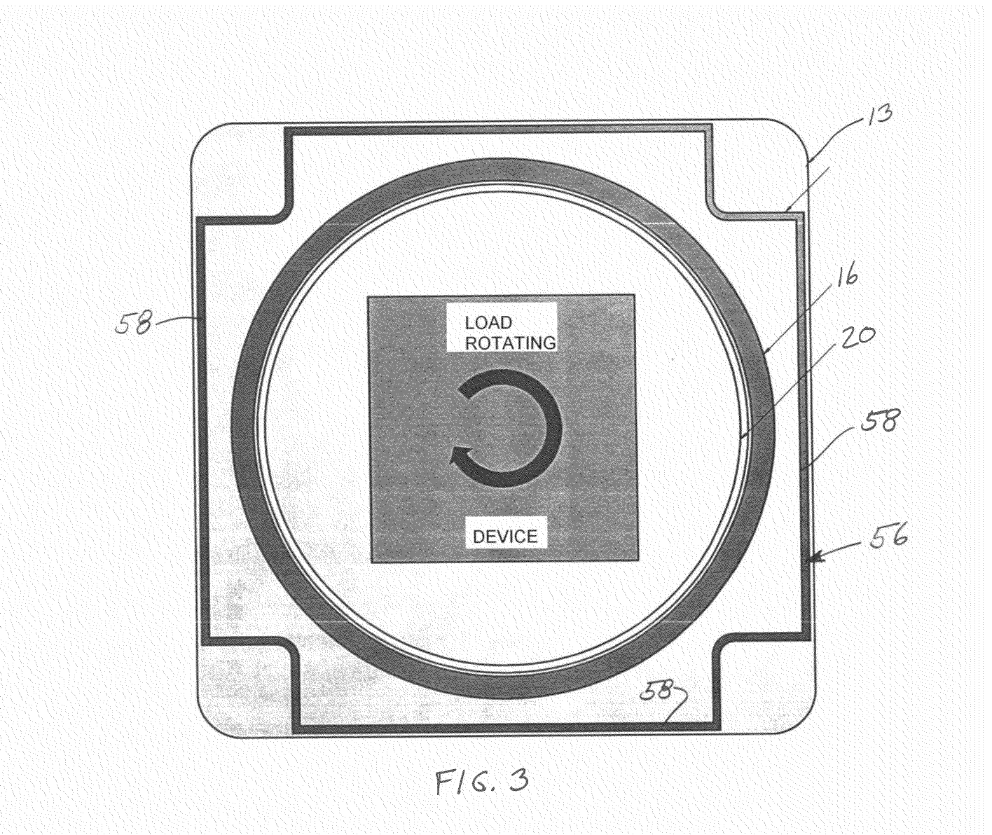

Referring now to the drawings wherein like reference numerals refer to the same or similar features among the several views, and in particular to FIGS. 1 to 3, there is shown a first embodiment of a quenching apparatus in accordance with the present invention. The quenching apparatus 10 has a base 11 that is preferably mounted on a base plate 12. The quenching apparatus 10 also includes a removable cover 14. The removable cover 14 preferably has a generally cylindrical portion 16 and a domed portion 18. Preferably, the cylindrical portion 16 and the domed portion 18 are welded together to form an integral housing unit. When assembled, the removable cover has an inverted, cup-like, interior recess.

The removable cover 14 is mounted on an upper housing 13 that is supported by support columns 15 that extend from the base plate 12 externally relative to the base 11 and the upper housing 13. Preferably, there are four support columns spaced at respective angular positions around the base plate. The tops of support columns 15 are preferably attached to a support plate 17. The removable cover 14 has a flange 19 formed around the circumference of the cylindrical portion 16. The removable cover is mounted on the support plate 17 at the top of the upper housing 13, preferably by bolting the flange 19 to the support plate 17. The support columns 15 are dimensioned so that the upper housing 13 is vertically spaced from the base 11 at a distance that provides an opening between the upper housing 13 and the base 11. The opening is commensurate in diameter with the upper housing and the base and has a height that is sufficient to permit a workload of heat treated parts to pass through. The opening is configured so that the interior of the quenching chamber can be accessed at almost any position around its circumference. With this arrangement, a workload can be moved into or out of the quench chamber at any of numerous locations. A loader/manipulator is preferably provided in the base 11 for supporting the workload inside the quenching apparatus 10. The loader/manipulator is preferably constructed to move the workload into and out of the quenching apparatus through the opening. The loader/manipulator may also be adapted to rotate the workload inside the quenching chamber during a quenching cycle and to position the workload for moving the workload into or out of the quenching apparatus at a selected position.

The quenching apparatus 10 also has a door 20 for closing the chamber when a workload is to be quenched. The door 20 is formed of a cylindrical wall that is dimensioned to fit within the recess of the upper housing. The door 20 is adapted to move, preferably by sliding, between a first position in the interior recess of the removable cover 14 and a second position in which the door extends between the upper housing 13 and the base 11 to fully close the opening between the base 11 and the upper housing 13. The door 20 is sealed to the upper housing 13 by means of an upper set of seals. Likewise, the door 20 is sealed to the base 11 by means of a lower set of seals. The seals are mounted in grooves that extend around the entire inner circumferences of the upper housing and the base. The seals are preferably configured as retractable seals such that they can be expanded when the door is in the closed position during a quenching cycle. The seals are adapted to retract into the grooves to provide clearance so that the door 10 can be moved between the open and closed positions without damaging the seals. Preferably, the seals are connected to an energy source for activating the seals when the door 20 is closed. In order to reduce the possibility of a seal failure when a quenching cycle is in progress, a fail-safe system is preferably utilized. Preferably, the fail-safe system is realized by providing redundant seals. In a preferred embodiment, the upper set of seals includes at least two seals and two distinct energy supplies, one for each of the seals. Likewise, the lower set of seals includes at least two seals and a separate energy source for each of those seals. In addition to the seal-energizing sources, means for retracting the seals is also provided so that the seals can be fully refracted when the door 20 is moved to close or open the quenching chamber.

Because the opening between the base and the upper housing extends about 360°, means are provided to isolate the interior of the quenching chamber. As shown in FIG. 3, a vacuum shell 56 is attached around the outside of the quenching apparatus. The vacuum shell 56 is preferably welded to the exteriors of the stationary parts of the quenching apparatus 10, namely, to the base 11 and to the upper housing 13. The vacuum shell has openings formed therein at two or more locations. The positions of the openings are selected to provide access for loading and unloading a work load into and out of the quenching apparatus from or to adjacent heat treating chambers. One of the openings is positioned to permit the work load to be loaded into the quenching apparatus from the ambient environment or to be unloaded to the ambient environment. The vacuum shell 56 includes flanges 58 formed around each of the openings. The flanges 58 are constructed and arranged so that sliding or gate-type pressure-tight/vacuum-tight doors can be affixed between the openings in the vacuum shell and the openings in the adjacent treating chambers and in a loading/unloading station. Such doors are well known in the art.

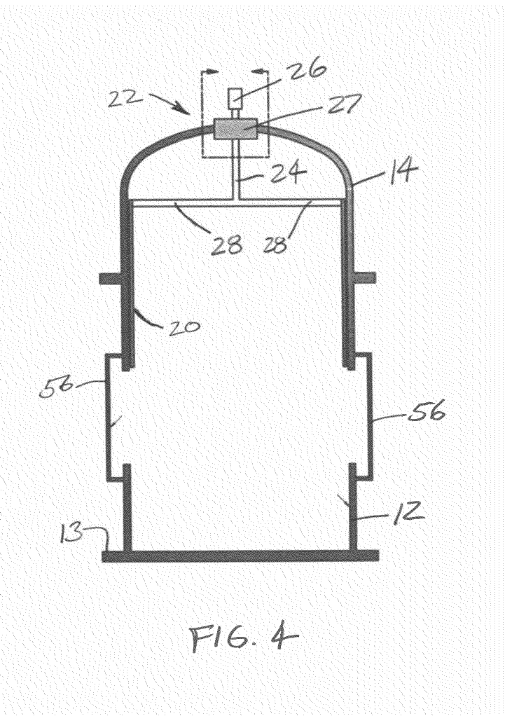

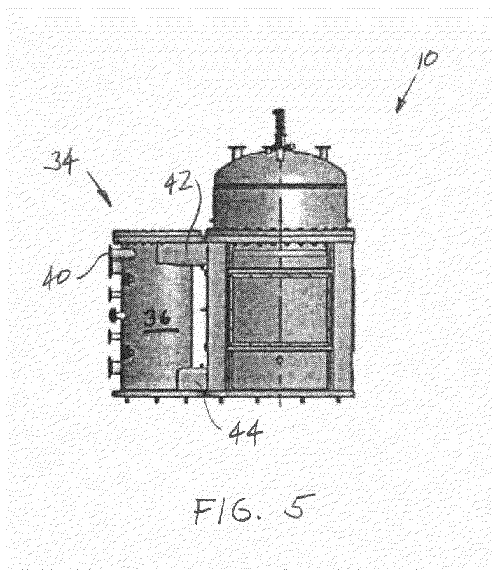

Referring now to FIG. 4, there is shown a first embodiment of an arrangement for lifting and lowering the door 20. In the embodiment shown in FIG. 4, the door 20 is operated between the open and closed position by a lift mechanism 22. Preferably, the lift mechanism is realized as a mechanical screw device 24, such as a ball screw, which is arranged to provide vertical displacement of the door. A drive motor 26, which is preferably a servo-motor, is affixed to the top of the removable cover 14. The drive shaft of the motor 26 is coupled to the mechanical screw device 24 through the removable cover 14. A sealing module 27 is provided around the drive shaft where it penetrates the removable cover 14 to prevent leakage into or out of the quenching chamber during either a vacuum step or a gas pressurization step in a quenching cycle. The sealing module can be readily designed and constructed by one skilled in the art.

The mechanical screw device 24 is connected to the door 20 with connector arms 28 that are attached to the inside of the door 20 and extend radially inward. The connector arms 28 are coupled to the thread portion of the mechanical screw device in any known manner such that rotation of the thread portion by the drive motor 26 causes vertical motion of the door 20. Preferably, the connection is a ball-type nut or an internally threaded device. It is also contemplated that a hydraulic or pneumatic lift device can be used in place of the mechanical screw device 24. Persons skilled in the art can readily adapt a hydraulic or pneumatic lift device for use in the quenching chamber according to this invention.

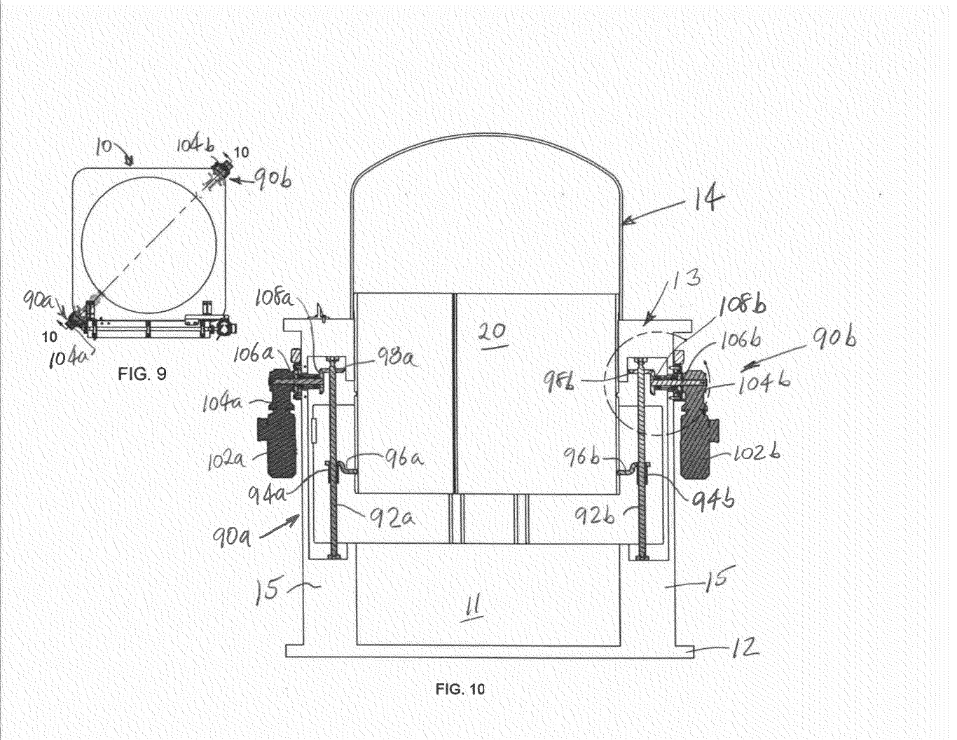

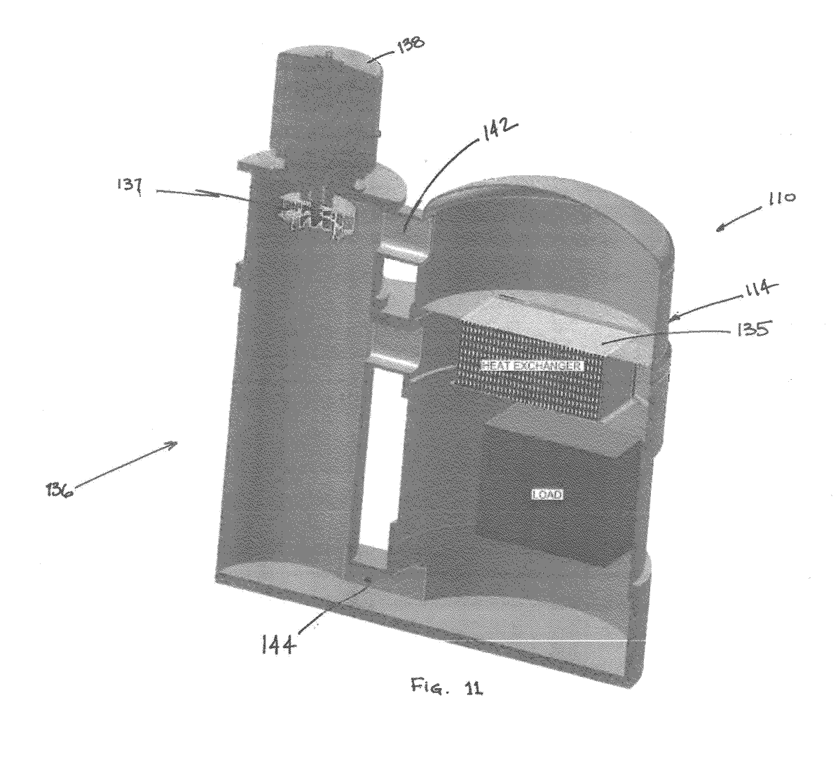

Referring now to FIGS. 9 and 10, there is shown a second embodiment of the arrangement for lifting and lowering the door 20. This embodiment includes a pair of mechanical lift devices 90a and 90b that are preferably located at diametrically opposing corners of the quenching apparatus 10. The mechanical lift device 90a includes a mechanical lifting means situated in one of the support columns 15. The second lift device 90b is situated in another support column 15 that is located diametrically opposite the first support column. Preferably, the mechanical lifting means are embodied as jack screws 92a and 92b. The jack screws 92a and 92b have traveler members 94a and 94b, respectively, which are configured to traverse the jack screws in the known manner when the jack screws are rotated about their long axes. Connecting links 96a and 96b are provided to interconnect the traveling members 94a and 94b with the door 20. Drive gears 98a and 98b are attached to the respective upper portions of the jack screws 92a and 92b, respectively.

The mechanical lift devices 90a and 90b both include drive means for causing rotation of the jack screws 92a and 92b. The drive means for the lift devices includes electric motors 102a and 102b which are mounted externally to the quenching apparatus 10. The drive means further includes a gear box 104a that is operatively coupled to electric motor 102a and a second gear box 104b that is operatively coupled to electric motor 102b. A drive shaft 106a extends from the gear box 104a into the support column 15. A coupling gear 108a is mounted on the end of the drive shaft 106a so that it engages with the drive gear 98a. In a similar manner, a second drive shaft 106b extends from a second gear box 104b into the other support column. A second coupling gear 108b is mounted on the end of the drive shaft 106b so that it engages with the drive gear 98b.

Regardless of the type of lift mechanism that is used, the drive mechanism or actuator is preferably configured so that if failure occurs, the door 20 will remain in the closed position. Such an operating condition can be readily designed by a person skilled in the art.

The construction of the quenching apparatus in accordance with the present invention provides significant flexibility in the quenching methods that can be performed. In fact, the quenching apparatus of this invention is equipped for using a variety of quenching media and techniques. Preferably, the quenching apparatus is equipped to provide gas quenching, liquid quenching, such as oil or water, with or without vacuum, quenching with a cryogenic fluid, such as liquid nitrogen, combinations thereof. The quenching medium is preferably flowed through the quench chamber in a top-to-bottom direction, although it will be appreciated by those skilled in the art that the quenching chamber can be alternatively designed to permit bottom-to-top flow of the quenching medium. For liquid quenching, the quenchant can be flooded or sprayed over the work load. In a further alternative embodiment, the quenching chamber is constructed to provide lateral injection of the quenching medium utilizing baffles, nozzles, or a combination thereof.

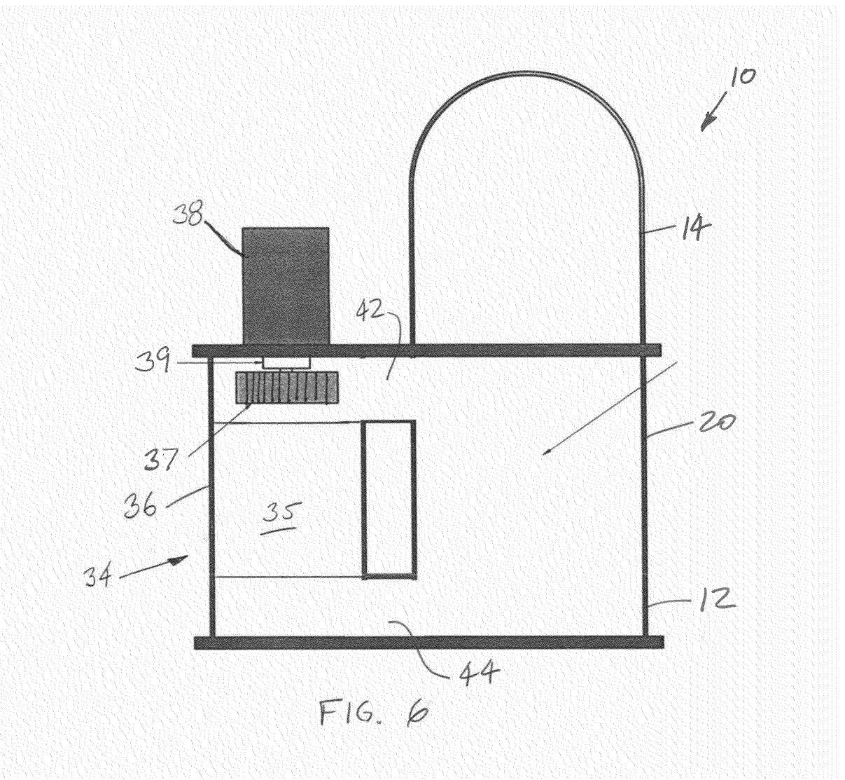

Referring now to FIGS. 5 and 6, there is shown a gas recirculation apparatus 34 attached to the quenching apparatus 10. The gas recirculation apparatus 34 includes a chamber that is preferably located adjacent to the quenching apparatus 10. The chamber 36 contains a heat exchanger 35. A fan 37 is provided inside the chamber 36 to circulate a cooling gas through the quenching chamber during a cooling cycle. The fan 37 is connected to an external drive motor 38. A seal 39 is provided around the fan drive shaft where the shaft penetrates the top of the gas recirculation apparatus 34. Seal 39 is adapted to provide a gas-tight, vacuum-tight seal. A gas injection port 40 is provided in the chamber wall at a location near the upper end of the chamber. A gas inlet duct 42 is connected between the upper end of chamber 36 and the upper housing 14 of the quench apparatus 10. A gas outlet duct 44 is connected between the base 12 and the lower end of chamber 36. In operation during a forced gas quenching cycle, an inert cooling gas such as nitrogen or argon is injected into chamber 36 through the gas injection port 40. The gas is injected at sufficient pressure to provide a flow velocity that causes the gas to traverse through the gas inlet duct 42 and into the quenching chamber. The fan is then operated to force the cooling gas through the cooling chamber where it absorbs heat from the workload. The heated gas is drawn out of the quenching chamber through the gas outlet duct 44 where it traverses the heat exchanger 35. The heat exchanger 35 preferably contains a coolant that absorbs heat from the circulating gas. The coolant is preferably circulated out to an external heat sink (not shown) which removes the absorbed heat from the coolant which is then recirculated through the heat exchanger 35 in the chamber 36. Additional ports are provided on the chamber 36 to permit connections for the exit and return of the heat exchanger coolant. It is contemplated that the gas can be provided a very high pressures, for example 5 bar, 10 bar, 15 bar or higher, in order to provide more rapid cooling when desired.

A second embodiment for the gas cooling apparatus is shown in FIG. 11. In this embodiment, the heat exchanger 135 is suspended from the removable cover 114 inside the quenching chamber. With this arrangement, the heat exchanger is located directly over a workload during a cooling cycle. The chamber 136 is taller in height than in the first embodiment so that a forced gas inlet 142 connects the chamber 136 with the interior recess of the removable cover 114. The axis of the gas inlet 142 is positioned to be vertically above the heat exchanger 135. A forced gas outlet 144 connects the chamber 136 with the interior of the quenching chamber in the vicinity of the upper housing. The axis of the gas outlet 144 is positioned vertically below the workload.

The quenching apparatus according to this invention can also be used with a liquid quenchant such as oil or water. To that end a liquid injection port is provided in the upper housing, preferably in the dome portion thereof. A drain port is provided at a lower portion of the base so that the liquid quenchant can be drained from the system after the completion of a quenching cycle. When a liquid quenching cycle such as oil quenching is used, it may be desirable to maintain the quenching chamber at a slight subatmospheric pressure (partial vacuum). Accordingly, a vacuum connection port is also provided on the quenching chamber for connecting a vacuum pump thereto. Alternatively, it may be desired to apply a partial positive pressure, for example, a slight superatmospheric pressure, of an inert gas during a liquid quenching cycle. In such a cycle, the inert gas can be injected as described above, but need not be forced by the fan.

In accordance with another aspect of this invention, there is provided means for injecting a cryogenic fluid such as liquefied nitrogen into the quenching chamber. Toward that end, a cryogenic fluid injection port is also provided in the upper housing, preferably in the dome portion thereof. In connection with this aspect of the invention it is contemplated that a spraying apparatus is provided in the upper housing so that the cryogenic fluid can be sprayed as a mist during a quenching cycle. As will be appreciated by those skilled in the art, a liquefied gas such as liquid nitrogen readily vaporizes as it absorbs heat. Therefore, the pressure in the quenching chamber will be expected to increase rapidly during a quenching cycle. In order to control the rate of pressure increase and limit the peak pressure, an exhaust port can be provided through the upper housing for allowing the vaporized gas to vent. Various configurations for quenching with a cryogenic fluid are described in copending U.S. Provisional Patent Application No. 61/468,267, filed Mar. 3, 2011, the entirety of which is incorporated herein by reference.

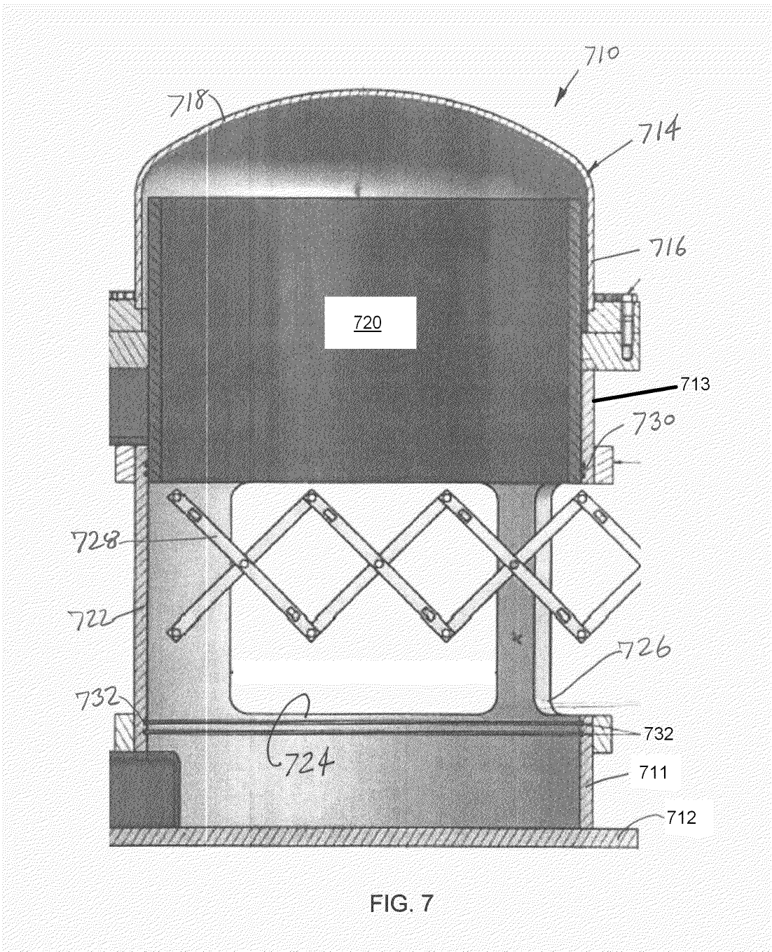

Referring now to FIG. 7, there is shown another embodiment of the quenching apparatus in accordance with the present invention. The quenching apparatus 710 includes a base 711, an upper housing 713, and a removable cover 714. The quenching apparatus 710 also includes a door 720 for closing the chamber when a workload is to be quenched. The door 720 is formed of a cylindrical wall that is dimensioned to fit within the recess of the upper housing 713. The door 720 is adapted to move, preferably by sliding, between a first position in the upper housing recess and a second position in which the door extends between the upper housing 713 and the base 711. The door 720 is sealed to the upper housing 713 by means of an upper set of seals 730. Likewise, the door 720 is sealed to the base 711 by means of a lower set of seals 732. The base 711, the upper housing 713, and the sliding door 720 are constructed similarly to the same features shown in FIGS. 1-3 and described above. As shown in FIG. 7, the quenching apparatus 710 also includes a generally cylindrical wall 722 that extends between the base 711 and the upper housing 713 and is aligned coaxially therewith. The wall 722 has an inside diameter that is dimensioned to permit the door 720 to slide therein. The wall 722 has a first port or window 724 and a second port or window 726 formed therein at spaced angular intervals. A third port (not shown) can be located diametrically across from port 724. The ports are dimensioned so that a workload can pass therethrough. A loader/manipulator 728 is provided in the base 711 for supporting a workload inside the quenching apparatus 710. The loader/manipulator is preferably constructed to rotate the workload to move the workload into and out of the quenching apparatus through port 724 or port 726. The loader/manipulator may also be adapted to rotate the workload inside the quenching chamber during a quenching cycle to provide more uniform cooling.

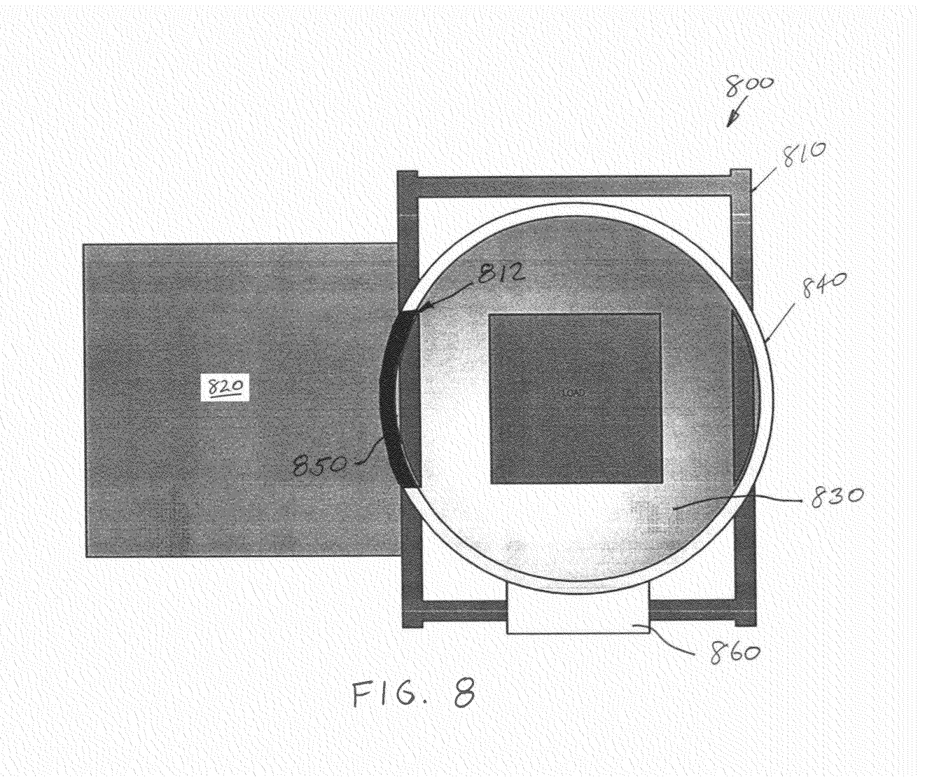

Referring now to FIG. 8, there is shown a further embodiment of a quenching apparatus according to the present invention. In this embodiment, the apparatus 800 includes a housing 810. The housing 810 has one or more ports 812 formed therein to provide a channel between the quenching apparatus 800 and one or more external treating chambers, such as heating chamber 820. A quenching chamber 830 is disposed inside the housing 810. The quenching chamber 830 has a generally spherical wall 840 that defines the outer limits of the quenching chamber 830. The wall 840 has a single opening 850 formed therein. The opening 850 is dimensioned and positioned to be aligned with the port 812 in housing 810. Port 812 and opening 850 are commensurately dimensioned so that a workload can pass therethrough when they are aligned.

An actuator 860 is operably coupled to the wall 840 and is adapted to rotate the wall 840 within the housing 810. In a preferred embodiment, the wall 840 is rotatably mounted in the housing 810. The actuator 860 can be operated to rotate the wall 840 either clockwise or counterclockwise to a first position where the chamber 830 is closed for a quenching cycle to be performed. The actuator 860 can also be operated to rotate the wall 840 to a second position where the opening 850 is aligned with port 812 so that a work load can be loaded into or out of the quenching chamber 830.

The quenching chamber 830 includes means for supporting the workload. The workload supporting means may also include a loader/manipulator as described above in connection with the other embodiments of the present invention. The loader/manipulator is preferably constructed to rotate the workload and to move the workload into and out of the quenching chamber 830 through opening 850. The loader/manipulator may also be adapted to rotate the workload inside the quenching chamber during a quenching cycle to provide more uniform cooling.

In view of the foregoing description, some of the advantages provided by the system according to the present invention should now be apparent. For example, a stationary quenching chamber for a multi-station heat treating system is constructed and arranged to communicate with two or more treating chambers and a loading/unloading chamber. Because the quench chamber is stationary, all of the utility connections for gas, water, power, and vacuum are simplified. The quenching chamber includes a single integral sliding door with a novel sealing arrangement. The door is constructed and arranged to open or close a 360° opening in the quenching chamber so that multiple transfer ports can be accessed with a single door. Moreover, the quenching chamber described is equipped to utilize a variety of quenching media and techniques such as gas cooling, liquid quenching, and cryogenic fluid quenching. Thus, the quenching chamber according to the present invention provides the capability to conduct numerous different quenching cycles with a single chamber. The chamber described herein also includes an integral loader that is configured to rotate within the chamber so that a work load can be loaded or unloaded at any of a number of positions. This arrangement also provides the ability to rotate the load during a quenching cycle.

The terms and expressions which have been employed are used as terms of description and not of limitation. There is no intention in the use of such terms and expressions of excluding any equivalents of the features or steps shown and described or portions thereof. It is recognized, therefore, that various modifications are possible within the scope and spirit of the invention. Accordingly, the invention incorporates variations that fall within the scope of the invention as described.

1. A quenching apparatus for the cooling of a heat treated workload comprising:
a generally cylindrical vessel that includes a base and an upper housing,
means for supporting a workload of heat treated parts within said vessel;
a removable cover having a generally cylindrical portion that is open at a lower end thereof and a domed portion affixed to the upper housing of the cylindrical vessel whereby said removable cover provides a cup-shaped recess;
means for supporting said removable cover above said upper housing in spaced vertical coaxial relation such that an passageway is defined between said cylindrical vessel and said removable cover;
a generally cylindrical door dimensioned and arranged to be coaxial within said cylindrical vessel; and
an actuator coupled to said cylindrical door for moving said door between an open position inside said removable cover and a closed position wherein said door extends between said upper housing and said base for closing the opening to thereby provide a quenching chamber.

2. A quenching apparatus as claimed in claim 1 comprising:
a first retractable seal affixed around the inner circumference of the cylindrical portion of said upper housing;
a second retractable seal affixed around the inner circumference of the cylindrical base; and
means for expanding and retracting said first and second retractable seals to provide a pressure-tight seal between said door and said base and between said door and said upper housing.

3. A quenching apparatus as claimed in claim 1 comprising a generally cylindrical wall disposed coaxially between and commensurate with said base and said upper housing so as to enclose the opening between said base and said upper housing, said cylindrical wall having at least two ports formed therein at spaced angular locations around the circumference of said wall, said ports being dimensioned to permit a workload to be moved therethrough.

4. A quenching apparatus as claimed in claim 1 comprising means for gas quenching of a workload, said gas quenching means comprising:
gas recirculation chamber;
a heat exchanger;
a port for injecting a cooling gas;
a fan disposed in said gas recirculation chamber;
a gas inlet duct connected between the gas recirculation chamber and the quenching chamber; and
a gas outlet duct connected between the gas recirculation chamber and the quenching chamber.

5. A quenching apparatus as claimed in claim 1 comprising a port for injecting a quenching liquid into the quenching chamber.

6. A quenching apparatus as claimed in claim 1 comprising a port for injecting a cryogenic fluid into the quenching chamber.
